(19) United States
(12) Patent Application Publication
(10) Pub. No.: US 2006/0214144 A1
(43) Pub. Date: Sep. 28, 2006

(54) Phosphorus-containing thermally stabilized flame retardant agglomerates

(75) Inventors: Harald Bauer, Kerpen (DE); Sebastian Hoerold, Diedorf (DE); Werner Krause, Huerth (DE)

Correspondence Address: CLARIANT CORPORATION;INTELLECTUAL PROPERTY DEPARTMENT, 4000 MONROE ROAD, CHARLOTTE, NC, 28205, US

(73) Assignee: CLARIANT Produkte (Deutschland) GmbH

(21) Appl. No.: 11/388,916

(22) Filed: Mar. 24, 2006

(30) Foreign Application Priority Data
Mar. 26, 2005 (DE) 10 2005 013 957.4

(51) Int. Cl. C09K 21/00

(52) U.S. Cl. 252/609

(57) ABSTRACT

The invention relates to phosphorus-containing thermally stabilized flame retardant agglomerates, comprising as component A from 6 to 99.99% by weight of aggregates and/or primary particles composed of a phosphinic salt of the formula (I) and/or of a diphosphinic salt of the formula (II), and/or of their polymers, 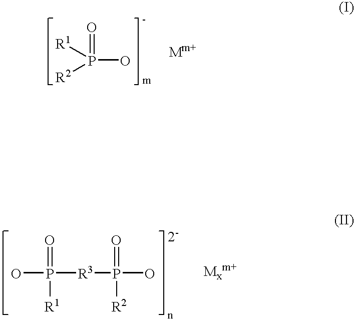 where
R¹ and R² are identical or different and are C1-C6-alkyl, linear or branched, and/or aryl;
R³ is C₁-C₁₀-alkylene, linear or branched, C₆-C₁₀-arylene, -alkylarylene, or -arylalkylene; M is Mg, Ca, Al, Sb, Sn, Ge, Zn, Ti, Fe, Zr, Ce, Bi, Sr, Mn, Li, Na, K, and/or a protonated nitrogen base; m is from 1 to 4; n is from 1 to 4; and x is from 1 to 4; as component B from 0 to 90% by weight of a synergist which comprises a nitrogen compound or which comprises a phosphorus compound, or which comprises a phosphorus-nitrogen compound; as component C from 0 to 20% by weight of compounds of the elements of the second main and transition group; and as component D from 0.01 to 20% by weight of auxiliary. The invention also relates to a process for their production, and to their use.

The present invention is described in the German priority application No. 10 2005 013 957.4, filed 26.03.2005, which is hereby incorporated by reference as is fully disclosed herein.

The invention relates to phosphorus-containing thermally stabilized flame retardant agglomerates having high thermal stability with respect to discoloration which comprise aggregates and/or primary particles composed of phosphinic salts and/or of diphosphinic salts, and/or of their polymers, and which cohere with the aid of an auxiliary. The invention also relates to a process for preparation of these phosphorus-containing flame retardant agglomerates and to the use of the same as flame retardants in polymers.

According to the prior art (DE-A-103 47 012), phosphorus-containing flame retardants can be prepared via spray agglomeration. That process uses binders which are intended to stabilize the agglomerate mechanically.

The agglomerates described in the prior art are disadvantageous because they discolor on heating. Since heating of this type takes place during the correct processing of the agglomerates to give flame-retardant molding compositions or to give flame-retardant moldings, disadvantageous discoloration also occurs in these products.

It is an object of the present invention to provide phosphorus-containing thermally stabilized flame retardant agglomerates which have substantially more thermal stability with respect to discoloration.

This object is achieved via an agglomerate of a phosphorus-containing flame retardant, which comprises a suitable auxiliary.

Flame Retardant Agglomerates

Surprisingly, it has been found that selection of a suitable auxiliary can substantially prevent the discoloration of the phosphorus-containing flame retardant agglomerates during heating.

The invention therefore provides phosphorus-containing thermally stabilized flame retardant agglomerates comprising as component A from 6 to 99.99% by weight of aggregates and/or primary particles composed of a phosphinic salt of the formula (I) and/or of a diphosphinic salt of the formula (II), and/or of their polymers, 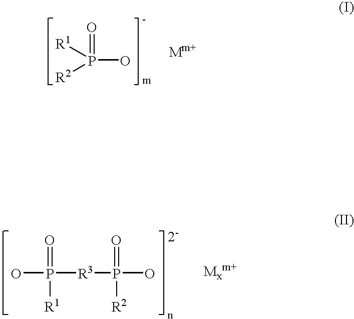
where
R¹ and R² are identical or different and are C1-C6-alkyl, linear or branched, and/or aryl;
R³ is C₁-C₁₀-alkylene, linear or branched, C₆-C₁₀-arylene, -alkylarylene, or -arylalkylene;
M is Mg, Ca, Al, Sb, Sn, Ge, Zn, Ti, Fe, Zr, Ce, Bi, Sr, Mn, Li, Na, K, and/or a
   protonated nitrogen base;
m is from 1 to 4; n is from 1 to 4; and x is from 1 to 4;
   as component B from 0 to 90% by weight of a synergist which comprises a nitrogen compound or which comprises a phosphorus compound, or which comprises a phosphorus-nitrogen compound;
   as component C from 0 to 20% by weight of compounds of the elements of the second main and/or transition group; and
   as component D from 0.01 to 20% by weight of auxiliary.

The phosphorus-containing thermally stabilized flame retardant agglomerates preferably comprise

from 20 to 99.9% by weight of component A

from 0 to 74% by weight of component B

from 0 to 10% by weight of component C

from 0.1 to 5% by weight of component D.

The phosphorus-containing thermally stabilized flame retardant agglomerates preferably comprise

from 6 to 99.99% by weight of component A

from 6 to 90% by weight of component B

from 0 to 20% by weight of component C

from 0.01 to 20% by weight of component D.

The phosphorus-containing thermally stabilized flame retardant agglomerates preferably comprise

from 20 to 99.9% by weight of component A

from 20 to 74% by weight of component B

from 0 to 10% by weight of component C

from 0.1 to 5% by weight of component D.

The phosphorus-containing thermally stabilized flame retardant agglomerates preferably comprise

from 6 to 99.89% by weight of component A

from 6 to 90% by weight of component B

from 0.1 to 20% by weight of component C

from 0.01 to 20% by weight of component D.

The phosphorus-containing thermally stabilized flame retardant agglomerates preferably comprise

from 20 to 98.9% by weight of component A

from 20 to 74% by weight of component B

from 1 to 10% by weight of component C

from 0.1 to 5% by weight of component D.

The entirety of the components therefore is always 100% by weight.

Component B is preferably melamine phosphate, melamine pyrophosphate, melamine polyphosphates, melam polyphosphates, melem polyphosphates, melon polyphosphates, melamine cyanurate, and/or melamine condensates, such as melam, melem, and/or melon.

Component C is preferably compounds of the elements calcium, magnesium, and/or zinc.

Component C is preferably magnesium hydroxide, magnesium carbonate, magnesium borate, calcium carbonate, calcium borate, calcium pyroborate, zinc oxide, zinc hydroxide, zinc borate, zinc phosphate, and/or zinc pyrophosphate.

The auxiliary is preferably homopolymers or mixed polymers based on at least one monomer from the group of 1,2-butadiene, 1,3-butadiene, 2-ethylhexyl acrylate, acrylamide, acrylic ester, acrylonitrile, acrylic acid, amides, caprolactam, crotonic acid, dibutyl maleate, epoxides, esters, ethyl acrylate, ethylene, ethylene glycol, ethylhexyl acrylate, ethyl methacrylate, hydroxyacrylic acid, isobutyl acrylate, isobutyl methacrylate, lauryl acrylate, maleic acid, maleic anhydride, methacrylamide, methacrylate, methacrylonitrile, methacrylic acid, methallylsulfonic acid, methyl methacrylate, methylstyrene, lactic acid, mono-, di-, or oligosaccharides, n-butyl acrylate, n-butyl methacrylate, n-hexyl acrylate, n-hexyl methacrylate, N-hydroxymethylacrylamide, n-propyl acrylate, N-vinylpyrrolidone, olefins, polyvinyl butyral, polyvinylcaprolactam, propylene, sec-butyl acrylate, stearates, styrene, styrenesulfonic acid, tert-butyl acrylate, tert-butyl chloride, tert-butyl methacrylate, urethanes, vinyl acetate, vinyl alcohol derivatives, vinylcaprolactam, vinyl chloride, vinyl ester, vinyl ethers, vinylidene chloride, vinyl laurate, vinyl methyl ethers, vinyl propionate, vinylpyrrolidone, degraded starch, aldehyde starches, alkylcellulose, alkylhydroxyethylcellulose, alkyl preferably being methyl, carboxyalkylcellulose (Na salt), hydroxyethylcellulose, hydroxypropylcellulose, sodium carboxymethylcellulose, and/or a mixture thereof.

Other preferred auxiliaries are polyvinylpyrrolidone, polycarboxylates, polystyrenesulfonic acid, polystyrenesulfonic acid-maleic anhydride copolymers, waterglass, vinyl acetate polymers, acrylate polymers, polylactic acid, starch, and/or cellulose derivatives.

Preferred L color values of the inventive phosphorus-containing thermally stabilized flame retardant agglomerates after heat treatment are from 80 to 99.9, particularly preferably from 85 to 98.

Preferred a color values for the inventive phosphorus-containing thermally stabilized flame retardant agglomerates are from −2 to +2, particularly preferably from −1 to +1.5.

Preferred b color values for the inventive phosphorus-containing thermally stabilized flame retardant agglomerates are from −2 to +8, particularly preferably from −1 to +7.

The invention also provides a process for preparation of phosphorus-containing thermally stabilized flame retardant agglomerates, which comprises agglomerating aggregates and/or primary particles composed of a phosphinic salt of the formula (I) and/or of a diphosphinic salt of the formula (II), and/or of their polymers 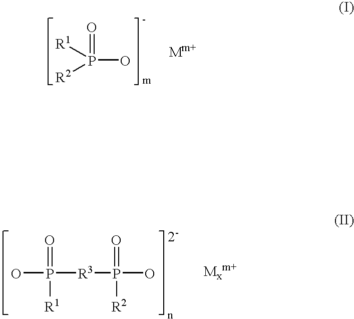
where
R¹ and R² are identical or different and are C1-C6-alkyl, linear or branched, and/or aryl;
R³ is C₁-C₁₀-alkylene, linear or branched, C₆-C₁₀-arylene, -alkylarylene, or -arylalkylene;
M is Mg, Ca, Al, Sb, Sn, Ge, Zn, Ti, Fe, Zr, Ce, Bi, Sr, Mn, Li, Na, K, and/or a
   protonated nitrogen base;
m is from 1 to 4, n is from 1 to 4; and x is from 1 to 4,
   in the presence of an auxiliary and, if appropriate, of a granulation aid, optionally removing the granulation aid, optionally sorting to extract agglomerates of suitable size, and optionally treating agglomerates of unsuitable size and returning them to the agglomerating process.

In the abovementioned process it is preferable to add at least one synergist which comprises a nitrogen compound, or which comprises a phosphorus compound, or which comprises a phosphorus-nitrogen compound, and/or compounds of the elements of the second main and/or transition group during the agglomeration process.

The invention also provides flame-retardant polymer molding compositions and flame-retardant polymer moldings, flame-retardant polymer films, flame-retardant polymer filaments, and flame-retardant polymer fibers, which comprise the inventive phosphorus-containing thermally stabilized flame retardant agglomerates as claimed in at least one of claims 1 to 14.

The flame-retardant polymer molding composition preferably comprises from 1 to 50% by weight of inventive phosphorus-containing thermally stabilized flame retardant agglomerates as claimed in at least one of claims 1 to 14,

from 1 to 99% by weight of polymer or a mixture of these

from 0 to 60% by weight of additives

from 0 to 60% by weight of filler.

The invention also provides a process for preparation of flame-retardant polymer molding compositions, which comprises homogenizing the inventive phosphorus-containing thermally stabilized flame retardant agglomerates as claimed in at least one of claims 1 to 14 with the granulated polymer material and, if desired, with additives in a compounding assembly at relatively high temperatures in the polymer melt and then drawing off and cooling the homogenized polymer strand and dividing it into portions.

The invention also provides polymer moldings, polymer films, polymer filaments, and polymer fibers comprising from 1 to 50% by weight of phosphorus-containing thermally stabilized flame retardant agglomerates as claimed in at least one of claims 1 to 14

from 1 to 99% by weight of polymer or a mixture of these

from 0 to 60% by weight of additives

from 0 to 60% by weight of filler.

The invention also provides flame-retardant polymer moldings, flame-retardant polymer films, flame-retardant polymer filaments, and flame-retardant polymer fibers which comprise flame-retardant polymer molding compositions as claimed in claim 16.

The flame-retardant polymer moldings, flame-retardant polymer films, flame-retardant polymer filaments, and flame-retardant polymer fibers preferably comprise from 60 to 98% by weight of flame-retardant polymer molding composition as claimed in claim 16,

from 2 to 40% by weight of polymer or a mixture of these.

The invention also provides a process for production of flame-retardant polymer moldings, of flame-retardant polymer films, of flame-retardant polymer filaments, or of flame-retardant polymer fibers, which comprises processing the flame-retardant polymer molding compositions as claimed in claim 16 via injection molding and compression molding, foam injection molding, internal-gas-pressure injection molding, blowmolding, cast-film methods, calendering, lamination, or coating at relatively high temperatures to give the flame-retardant polymer molding, and, if appropriate, flame-retardant polymer films, flame-retardant polymer filaments, and flame-retardant polymer fibers.

The average particle size of the inventive phosphorus-containing thermally stabilized flame retardant agglomerates is preferably from 0.1 to 3000 μm, particularly preferably from 100 to 3000 μm, and in particular from 200 to 2000 μm. Lower particle sizes do not provide freedom from dust. Larger particle sizes give products with increased abrasion value and with very low bulk density.

The bulk density of the inventive phosphorus-containing thermally stabilized flame retardant agglomerates is preferably from 80 to 1500 g/l, particularly preferably from 80 to 800 g/l, and in particular from 200 to 500 g/l and from 200 to 400 g/l. Lower bulk densities make it more difficult to incorporate the material into the polymer when using the extruder to give flame-retardant polymer molding compositions, because air content is high. Agglomeration cannot prepare greater bulk densities or can prepare them only with difficulty.

The residual moisture content of the phosphinate or, respectively, synergist aggregates used is preferably from 0.05 to 30% by weight, preferably from 0.1 to 50% by weight. Phosphinate or, respectively, synergist aggregates with higher residual moisture contents become impossible to handle because they tend to clump. Phosphinate or, respectively, synergist aggregates with lower residual moisture contents are difficult to prepare industrially. The average particle diameter of the phosphinate or, respectively, synergist aggregates used is preferably from 0.1 to 500 μm, particularly preferably from 1 to 100 μm.

The average particle diameter of the phosphinate or, respectively, synergist primary particles is preferably from 0.1 to 50 μm, particularly preferably from 1 to 10 μm.

Phosphinate or, respectively, synergist aggregates with greater average particle diameters give inhomogeneity in the flame-retardant polymer moldings. Phosphinate or, respectively, synergist aggregates with lower average particle diameter are difficult to prepare industrially.

The abovementioned color values are stated in the Hunter system (CIE-LAB-System, Commission Internationale d'Eclairage). L values extend from 0 (black) to 100 (white), a values from −a (green) to +a (red), and b values from −b (blue) to +b (yellow).

Phosphorus-containing thermally stabilized flame retardant agglomerates with L values below the inventive range mentioned on page 5 require greater use of white pigment. Diorganylphosphinic salts with a or b values outside the inventive range likewise require greater use of white pigment. This impairs the mechanical stability properties of the polymer molding (e.g. modulus of elasticity).

The abrasion value of the phosphorus-containing thermally stabilized flame retardant agglomerates is preferably from 30 to 95%, particularly preferably from 40 to 80%.

The residual moisture content of the phosphorus-containing thermally stabilized flame retardant agglomerates is preferably from 0.05 to 2, particularly preferably from 0.1 to 1, % by weight. Residual moisture levels outside the inventively preferred range impair compatibility with the polymer. This implies poorer strength and elasticity properties for the flame-retardant polymer molding compositions and for the flame-retardant polymer moldings.

According to the invention, the expression “phosphorus-containing thermally stabilized flame retardant agglomerates” also includes particles of a phosphorus-containing thermally stabilized flame retardant composition which are composed of primary particles and/or of aggregates/primary particles of a phosphinic salt of the formula (I) and/or of a diphosphinic salt of the formula (II), and/or of their polymers, and of at least one synergist, and which have been bound to one another via an auxiliary.

M in the formulae (I) and (II) is preferably calcium, aluminum, zinc, or titanium.

Protonated nitrogen bases are preferably the protonated bases of ammonia, melamine, or triethanolamine, in particular NH₄⁺.

R¹ and R², identical or different, are preferably C₁-C₆-alkyl, linear or branched, and/or phenyl.

R¹ and R², identical or different, are particularly preferably methyl, ethyl, n-propyl, isopropyl, n-butyl, tert-butyl, n-pentyl, and/or phenyl.

R³ is preferably methylene, ethylene, n-propylene, isopropylene, n-butylene, tert-butylene, n-pentylene, n-octylene, or n-dodecylene; phenylene or naphthylene; methylphenylene, ethylphenylene, tert-butylphenylene, methylnaphthylene, ethylnaphthylene, or tert-butylnaphthylene; phenylmethylene, phenylethylene, phenylpropylene, or phenylbutylene.

The synergist is preferably a synergist which comprises a nitrogen compound, or which comprises a phosphorus compound, or which comprises a phosphorus-nitrogen compound.

Suitable synergists are melamine phosphate (e.g. ®Melapur MPH, ®Melapur MP from Ciba-DSM Melapur), melamine acetate, dimelamine phosphate, pentamelamine triphosphate, trimelamine diphosphate, tetrakismelamine triphosphate, hexakismelamine pentaphosphate, melamine diphosphate, melamine tetraphosphate, melamine pyrophosphate (e.g. ®Budit 311 from Budenheim, ®MPP-B from Sanwa Chemicals), melamine polyphosphates, melam polyphosphates, melem polyphosphates, and/or melon polyphosphates. Particular preference is given to melamine polyphosphates such as ®Melapur 200/70, ®Melapur CGX FR231 from Ciba-DSM Melapur, ®Budit 3141, 3141 CA and 3141 CB, and melamine polyphosphate/melamine pyrophosphate of grades 13-1100, 13-1105, 13-1115, MPP02-244 from Hummel Croton, and ®PMP-100, or ®PMP-200 from Nissan Chemical Industries, Japan. Other suitable products are: ®Melapur MC 25, ®Melapur MC, or ®Melapur MC XL from Ciba-DSM Melapur, and melamine ammonium polyphosphates.

Preference is given in another embodiment to condensates of melamine (e.g. melam, melem, and/or melon), or to reaction products of melamine with phosphoric acid, or to reaction products of condensates of melamine with phosphoric acid, and also to mixtures of the products mentioned. Examples of condensates of melamine are melem, melam, or melon, or higher-condensation-level compounds of this type, and also mixtures of the same, and these can by way of example be prepared via a process described in WO-96/16948.

Reaction products with phosphoric acid are compounds produced via reaction of melamine or of the condensed melamine compounds, such as melam, melem, or melon, etc., with phosphoric acid. Examples of these are melamine polyphosphate, melam polyphosphate (®PMP-200™ from Nissan Chemical Industries), and melem polyphosphate (®PMP-300™ from Nissan Chemical Industries), or mixed polysalts, e.g. those described in WO 98/39306. The compounds mentioned have been disclosed previously in the literature and can also be prepared via processes other than direct reaction with phosphoric acid. By way of example, melamine polyphosphate can be prepared by analogy with WO 98/45364 via reaction of polyphosphoric acid and melamine, or by analogy with WO 98/08898 via condensation of melamine phosphate and, respectively, melamine pyrophosphate.

According to the invention, synergists to which further preference is given are oligomeric esters of tris(hydroxyethyl)isocyanurate with aromatic polycarboxylic acids, benzoguanamine, tris(hydroxyethyl)isocyanurate, melamine condensates, such as melam, melem, and/or melon, melamine cyanurate (e.g. ®Melapur MC or ®Melapur MC XL from Ciba-DSM Melapur), dicyandiamide, and/or guanidine.

According to the invention, synergists to which further preference is given are nitrogen-containing phosphates of the formulae (NH₄)yH₃-yPO₄ or (NH₄PO₃)z, where y is from 1 to 3, and z is from 1 to 10 000.

According to the invention, preferred synergists are nitrogen compounds such as allantoin, melamine, cyanuric acid, glycoluril, urea, and their derivatives, e.g. those of the formulae (III) to (VIII), or a mixture thereof 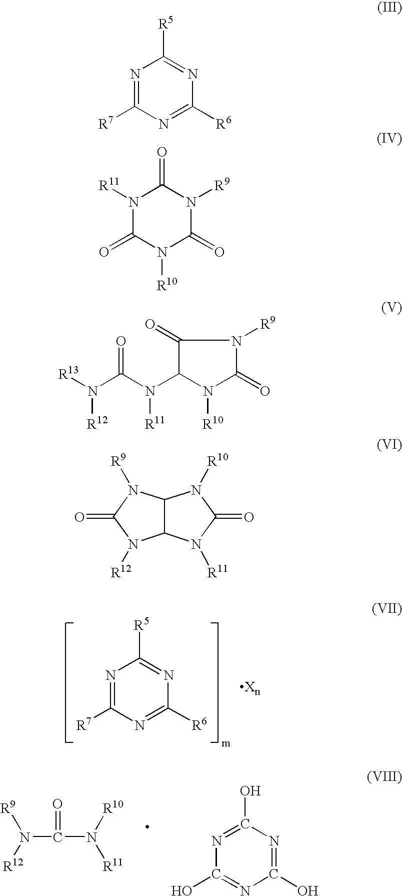
where
R⁵ to R⁷ are hydrogen, C₁-C₈-alkyl, C₅-C₁₆-cycloalkyl or -alkylcycloalkyl, where appropriate substituted with a hydroxy function or with a C₁-C₄-hydroxyalkyl function, C₂-C₈-alkenyl, C₁-C₈-alkoxy, -acyl, -acyloxy, C₆-C₁₂-aryl or -arylalkyl, —OR⁸, and
—N(R⁸)R⁹, including systems of N-alicyclic or N-aromatic type,
R⁸ is hydrogen, C₁-C₈-alkyl, C₅-C₁₆-cycloalkyl or -alkylcycloalkyl, where appropriate substituted with a hydroxy function or with a C₁-C₄-hydroxyalkyl function, C₂-C₈-alkenyl, C₁-C₈-alkoxy, -acyl, -acyloxy, or C₆-C₁₂-aryl or -arylalkyl,
R⁹ to R¹³ are groups identical with R⁸ or else —O—R⁸,
m and n, independently of one another, are 1, 2, 3, or 4, and
X is acids which can form adducts with triazine compounds (III).

Compounds of the elements of the second main and/or transition group are preferred synergists, particular preference being given to compounds of the elements calcium, magnesium, and zinc.

Among the magnesium compounds, preferred synergists are magnesium oxide, magnesium hydroxide (e.g. ®Magnifin H5 from Albermarle), magnesium oxide hydroxides, hydrotalcites, dihydrotalcite, magnesium carbonates, magnesium hydroxide carbonates, magnesium calcium carbonates, monobasic, dibasic, or tribasic magnesium phosphate, and/or magnesium pyrophosphate.

Among the calcium compounds, preferred synergists are calcium borate, calcium pyroborate, calcium carbonate, calcium hydroxide, monobasic, dibasic, tribasic calcium phosphate, and/or calcium pyrophosphate.

Zinc compounds are preferred synergists, e.g. zinc oxide (e.g. Zinkoxid aktiv from Rhein Chemie, Brüggemann KG, zincite, or calamine; standard zinc oxide, G6 zinc white, 2011 zinc oxide, F-80 zinc oxide, Pharma 8 zinc white, Pharma A zinc white, Rotsiegel zinc white, Weissiegel zinc white from Grillo-Werke AG), zinc hydroxide and/or zinc oxide hydrate.

Zinc salts of the oxo acids of the fourth main group are preferred synergists (anhydrous zinc carbonate, basic zinc carbonate, zinc hydroxide carbonate, basic zinc carbonate hydrate, (basic) zinc silicate, zinc hexafluorosilicate, zinc hexafluorosilicate hexahydrate, zinc stannate and/or zinc magnesium aluminum hydroxide carbonate).

Other preferred synergists are zinc salts of the oxo acids of the third main group (zinc borate, e.g. ®Firebrake ZB, ®Firebrake 415 from Borax).

Other preferred synergists are zinc salts of the oxo acids of the fifth main group (zinc phosphate, zinc pyrophosphate).

Synergists to which further preference is given are zinc salts of the oxo acids of the transition metals (zinc chromate(VI) hydroxide (zinc yellow), zinc chromite, zinc molybdate, e.g. ®Kemgard 911 B, zinc permanganate, zinc molybdate magnesium silicate, e.g. Kemgard 911 C from Sherwin-Williams Company, zinc permanganate).

Other zinc salts preferred as synergists are those having organic anions, e.g. zinc salts of mono-, di-, oligo-, or polycarboxylic acids (salts of formic acid (zinc formates), of acetic acid (zinc acetates, zinc acetate dihydrate, Galzin), of trifluoroacetic acid (zinc trifluoroacetate hydrate), zinc propionate, zinc butyrate, zinc valerate, zinc caprylate, zinc oleate, zinc stearate (®Liga 101 from Greven Fett-Chemie), of oxalic acid (zinc oxalate), of tartaric acid (zinc tartrate), of citric acid (tribasic zinc citrate dihydrate), of benzoic acid (benzoate), zinc salicylate, of lactic acid (zinc lactate, zinc lactate trihydrate), of acrylic acid, of maleic acid, of succinic acid, of amino acids (glycine), of acidic hydroxy functions (zinc phenolate, etc.), zinc para-phenolsulfonate, zinc para-phenolsulfonate hydrate, zinc acetylacetonate hydrate, zinc tannate, zinc dimethyldithiocarbamate and/or zinc trifluoromethanesulfonate.

Other preferred synergists are zinc phosphides, zinc sulfides, zinc selenides, and zinc tellurides.

Compounds of the elements of the third main group, particularly preferably of aluminum and of boron, are preferred synergists.

Aluminum compounds are preferred synergists, e.g. aluminum oxide, aluminum oxide hydroxide (boehmite, diaspore), aluminum hydroxide (bayerite, gibbsite, hydragillite), or aluminum phosphate.

Boron compounds are preferred synergists, e.g. boron phosphate. Tin compounds are preferred synergists, examples being tin oxide, tin oxide hydrates, stannous hydroxide, and/or tin sulfide.

Other preferred synergists are carbodiimides (e.g. ®Stabaxol 1, ®Stabaxol P, Stabaxol KE 9193 from Rhein Chemie), N,N′-dicyclohexylcarbodiimide, and/or polyisocyanates (e.g. ®Basonat HI 100 or ®Vestanat T 1890/100), carbonylbiscaprolactam (Allinco), or styrene-acrylic polymers (®Joncryl ADR-4357 from Johnson); sterically hindered phenols (e.g. ®Hostanox OSP 1), sterically hindered amines and light stabilizers (e.g. ®Chimasorb 944, ®Hostavin grades), phosphonites and antioxidants (e.g. Sandostab® P-EPQ from Clariant), and release agents (®Licomont grades from Clariant).

Auxiliaries

The selection of the auxiliary is such that on incorporation into the polymer the agglomerate breaks up into separate aggregates and/or primary particles whose average particle sizes are from 0.1 to 500 μm.

The auxiliary binds the aggregates and primary particles to one another, but not so strongly that they cannot disperse again in a polymer. This means that it is necessary to select different auxiliaries as a function of the process and/or process conditions to be used to incorporate the phosphorus-containing thermally stabilized flame retardant into polymers.

The auxiliary is preferably homopolymers or mixed polymers based on at least one monomer from the group of acrylic acid, amides, cellulose derivatives, epoxides, esters, hydroxyacrylic acid, methacrylic acid, olefins, stearates, urethanes, vinyl acetate, vinyl alcohol derivatives, vinylcaprolactam, vinylpyrrolidone, or a mixture thereof.

The auxiliary used preferably comprises a polyvinylpyrrolidone whose molecular weight is from 5000 to 2 000 000, preferably one whose molecular weight is from 5000 to 200 000, particularly preferably one whose molecular weight is from 7000 to 11 000, or, in another embodiment, one whose molecular weight is from 1 200 000 to 2 000 000.

Other auxiliaries whose use is preferred are polyvinyl alcohol, polyvinyl butyral (PVB), polyvinylcaprolactam, hydroxyethylcellulose, hydroxypropylcellulose, and/or sodium carboxymethylcellulose.

Polycarboxylates are particularly preferred auxiliaries.

Polymers based on at least one of the following monomers are preferred polycarboxylates: polyacrylates, polyhydroxyacrylates, polymaleates, polymethacrylates, or a mixture thereof.

Examples of suitable polycarboxylates are the sodium salts of polyacrylic acid or of polymethacrylic acid, for example those whose molecular weight is from 800 to 150 000 (based on acid).

Particularly suitable copolymeric polycarboxylates are those of acrylic acid with methacrylic acid, acrolein, vinyl acetate, and of acrylic acid or methacrylic acid with maleic acid. Copolymers of acrylic acid with maleic acid which contain from 50 to 90% by weight of acrylic acid and from 50 to 10% by weight of maleic acid have proven particularly suitable. The ratio of acrylate units to maleate units in these copolymers can preferably be from 30:1 to about 1:1, particularly preferably from about 10:1 to 2:1. Their molecular weight, based on free acids, is generally from 2000 to 200 000, preferably from 10 000 to 120 000, and in particular from 50 000 to 100 000. Examples of commercially available products are ®Sokalan CP 5 and PA 30 from BASF, ®Alcosperse 175 mal 177 from Alco, ®LMW 45 from NorsoHAAS.

The polycarboxylate used preferably comprises a homo- and/or copolymer composed of acrylic acid, of methacrylic acid, of maleic acid, of polyaspartic acid, of sugar carboxylic acid, and/or of other monomers.

Among these are the homopolymers of acrylic acid or of methacrylic acid and, respectively, their copolymers with other ethylenically unsaturated monomers, such as acrolein, dimethylacrylic acid, ethylacrylic acid, vinylacetic acid, allylacetic acid, maleic acid, fumaric acid, itaconic acid, methallylsulfonic acid, vinylsulfonic acid, styrenesulfonic acid, acrylamidomethylpropanesulfonic acid, and monomers containing phosphoric acid groups, e.g. vinylphosphonic acid, allylphosphonic acid, and acrylamidomethylpropanephosphonic acid and salts thereof, and hydroxyethyl(meth)acrylate sulfates, allyl alcohol sulfates, and allyl alcohol phosphates.

Particularly suitable materials for the inventive application are biodegradable terpolymers which can be obtained via polymerization of
a) from 10 to 70% by weight of monoethylenically unsaturated dicarboxylic acids having from 4 to 8 carbon atoms or their salts
b) from 20 to 85% by weight of monoethylenically unsaturated monocarboxylic acids having from 3 to 10 carbon atoms or their salts
c) from 1 to 50% by weight of monounsaturated monomers which after hydrolysis have free hydroxy groups on the polymer chain
d) from 0 to 10% by weight of other monomers capable of free-radical copolymerization, where the entirety of the monomers of a) to d) is 100% by weight, in aqueous solution, and hydrolysis of the monomers of c).

Hydrolysis in an acidic medium is preferred for the inventive application.

Other suitable materials for the inventive application are graft polymers of monosaccharides, of oligosaccharides, of polysaccharides, and of modified polysaccharides. Graft polymers with animal or vegetable proteins, and also in particular with modified proteins, likewise have good suitability for the inventive application.

Among the group of the graft copolymers, it is preferable to use copolymers composed of sugar or of other polyhydroxy compounds and of a monomer mixture of the following constitution:
a) from 45 to 96% by weight of monoethylenically unsaturated C₃-C₁₀ monocarboxylic acid, or a mixture of C₃-C₁₀ monocarboxylic acids and/or their salts having monovalent cations
b) from 4 to 55% by weight of monoethylenically unsaturated monomers containing monosulfonic acid groups, of monoethylenically unsaturated sulfuric esters, of vinylphosphonic acid, and/or of the salts of these acids having monovalent cations
c) from 0 to 30% by weight of water-soluble, monoethylenically unsaturated compounds which have been modified with from 2 to 50 mol of alkylene oxide per mole of monoethylenically unsaturated compound.

Other suitable polymers are polyaspartic acids and their derivatives in non-neutralized or only partially neutralized form. The polyaspartic acids are usually produced in the form of their alkali metal salts or ammonium salts. From these it is possible to prepare the non-neutralized or only partially neutralized products via addition of appropriate amounts of organic or inorganic acids and, if appropriate, isolating the resultant salts.

These products can also be obtained via thermal reaction of maleic acid and ammonia or via condensation of aspartic acid and subsequent hydrolysis of the resultant polysuccinimide.

Particularly suitable materials for preparation of a soluble zinc compound of a polycarboxylic acid are graft polymers of acrylic acid, of methacrylic acid, of maleic acid, and of other ethylenically unsaturated monomers on salts of polyaspartic acid, these being the materials usually produced during the hydrolysis described above of the polysuccinimide. There is no need here for the addition, otherwise necessary, of acid to prepare the only partially neutralized form of the polyaspartic acid. The amount of polyaspartate is usually selected in such a way that the degree of neutralization of all of the carboxy groups incorporated in the polymer is not more than 80%, preferably not more than 60%.

Preferred ranges for the polymers described above are:

Average molar mass: from 1000 to 100 000 g/mol, preferably from 2000 to 70 000 g/mol, and particularly preferably from 2000 to 35 000 g/mol.

Degree of neutralization of acid groups: from 0 to 90%, preferably from 30 to 70%.

Water content of polymer solutions: from 30 to 70% by weight, preferably from 40 to 60% by weight.

Viscosity of polymer solutions: less than 2000 Pa*s at 20° C.

The pH of the polymer solution should be smaller than 5.5.

Other preferred auxiliaries are biodegradable polymers having more than two different monomer units, for example those which contain, as monomers, salts of acrylic acid and of maleic acid, and contain vinyl alcohol or vinyl alcohol derivatives, or those which contain, as monomers, salts of acrylic acid and of 2-alkylallylsulfonic acid, and contain sugar derivatives.

Copolymers of acrylic acid or methacrylic acid with vinyl ethers, for example with vinyl methyl ethers, vinyl ester, ethylene, propylene, and styrene are preferred auxiliaries when the proportion of the acid is at least 50% by weight.

Preferred polycarboxylates can be used in the form of their water-soluble salts, in particular in the form of the alkali metal salts, particularly of the sodium salts and/or potassium salts.

Other preferred polycarboxylates are terpolymers. Preferred terpolymers here contain from 60 to 95% by weight, in particular from 70 to 90% by weight, of (meth)acrylic acid or (meth)acrylate, particularly preferably acrylic acid or acrylate, and maleic acid or maleate, and from 5 to 40% by weight, preferably from 10 to 30% by weight, of vinyl alcohol and/or vinyl acetate. Very particular preference is given here to terpolymers in which the ratio by weight of (meth)acrylic acid or (meth)acrylate to maleic acid or maleate is from 1:1 to 4:1, preferably from 2:1 to 3:1, and in particular from 2.1:1 to 2.5:1. The amounts here are based on the acids, as also are the ratios by weight.

Terpolymers which are preferred polycarboxylates here are those which contain from 40 to 60% by weight, in particular from 45 to 55% by weight, of (meth)acrylic acid or (meth)acrylate, particularly preferably acrylic acid or acrylate, from 10 to 30% by weight, preferably from 15 to 25% by weight, of methallylsulfonic acid or methallylsulfonate, and, as third monomer, up to 40% by weight, preferably from 20 to 40% by weight, of a carbohydrate. This carbohydrate can by way of example be a mono-, di-, oligo-, or polysaccharide, preference being given here to mono-, di-, or oligosaccharides, and particular preference being given to sucrose.

Terpolymers which are preferred polycarboxylates are those whose molecular weight is from 1000 to 200 000, preferably from 200 to 50 000, and in particualr from 3000 to 10 000.

Terpolymers which are preferred polycarboxylates are those which have been either completely or at least partially neutralized, in particular to an extent of more than 50%, based on the carboxy groups present. Particular preference is given here to a completely neutralized terpolymer which is therefore composed of the salts of the monomeric acids, in particular of the sodium salts or potassium salts of the monomeric acids, and of vinyl alcohol or of a carbohydrate.

Polycarboxylates which are preferred auxiliaries are those which can be used either as powder or as aqueous solution, preference being given here to aqueous solutions whose strength is from 20 to 55% by weight.

Polymers which are preferred auxiliaries are those based on at least one of the following monomers or mixtures thereof: maleic acid, maleic anhydride, methylstyrene, styrene, styrenesulfonic acid. Particular preference is given here to homo- and copolymers of polystyrenesulfonic acid. Preference is given to polystyrenesulfonic acid homopolymers whose molecular weights are from 10 000 to 1 200 000.

Polystyrenesulfonic acid homopolymers in the form of aqueous solutions with from 20 to 50% by weight of active substance are preferred.

Polystyrenesulfonic acid homopolymers in the form of aqueous solutions with viscosities of from 5 to 1600 mPa*s are preferred.

Polystyrenesulfonic acid homopolymers in the form of aqueous solutions with pH values of from 7 to 11 are preferred.

Polystyrenesulfonic acid-maleic anhydride copolymers whose molecular weights are from 10 000 to 1 200 000 are preferred.

Polystyrenesulfonic acid copolymers with a styrenesulfonic acid:maleic acid molar ratio of from 1:1 to 4:1 are preferred.

Other materials which can be used as inventive auxiliaries are, inter alia, waterglass, vinyl acetate polymers, acrylates, polylactic acid, starch, and cellulose, and film-forming binders.

Waterglass

Alkali metal silicate solutions whose silicon dioxide/sodium oxide molar ratio is from 1:2 to 4:1 are preferred. The active substance content of the solutions is preferably from 5 to 50% by weight.

Vinyl Acetate Polymers

Polymers based on at least one of the following monomers or a mixture thereof are preferred: vinyl acetate, 2-ethylhexyl acrylate, acrolein, acrylic ester, acrylic acid, crotonic acid, dibutyl maleate, ethylene, methyl methacrylate, n-butyl acrylate, N-hydroxymethylacrylamide, N-vinylpyrrolidone, styrene, tert-butyl chloride, vinyl chloride, vinyl laurate, vinyl propionate.

Acrylates

Polymers based on at least one of the following monomers or a mixture thereof are preferred: methacrylate, 1,2-butadiene, 1,3-butadiene, 2-ethylhexyl acrylate, acrylamide, acrylonitrile, acrylic acid, ethyl acrylate, ethyl methacrylate, isobutyl acrylate, isobutyl methacrylate, lauryl acrylate, and/or methyl methacrylate, methacrylamide, methacrylonitrile, methacrylic acid, n-butyl acrylate, n-butyl methacrylate, n-hexyl acrylate, n-hexyl methacrylate, n-propyl acrylate, sec-butyl acrylate, styrene, tert-butyl acrylate, tert-butyl methacrylate, vinyl acetate, vinyl chloride, vinylidene chloride, vinyl propionate.

Polylactic Acid

Materials to which further preference is given are homopolymers of lactic acid (polylactides) or poly(lactide-caprolactone) copolymers, poly(lactide-glycolide) copolymers, poly(lactide-caprolactone-glycolide) terpolymers, poly(lactide-glycolide-ethylene glycol) terpolymers. The preferred molecular weights are from 5000 to 150 000.

Starch and Cellulose

It is also possible to use soluble starch preparations and starch products other than those mentioned above, e.g. degraded starch, aldehyde starches, etc.

Carboxyalkylcellulose (Na salt), hydroxyethylcellulose, hydroxypropylcellulose, alkylcellulose, alkylhydroxyethylcellulose, alkyl preferably being methyl.

Other auxiliaries are homopolymers based on vinyl acetate, copolymers based on vinyl acetate, ethylene, and vinyl chloride, copolymers based on vinyl acetate and on a vinyl ester of a long-chain, branched carboxylic acid, copolymers based on vinyl acetate and di-n-butyl maleate, copolymers based on vinyl acetate and acrylic ester, copolymers based on styrene and acrylic ester, copolymers based on acrylate/vinyltoluene, copolymers based on acrylate/styrene, copolymers based on acrylate/vinyl, and/or self-crosslinking polyurethane dispersions.

Process for Preparation of the Agglomerate

The invention also provides a process for preparation of phosphorus-containing thermally stabilized flame retardant agglomerates, which comprises agglomerating aggregates and/or primary particles composed of
a) a phosphinic salt of the formula (I) and/or of a diphosphinic salt of the formula (II), and/or of their polymers, and, if appropriate,
b) of at least one synergist, in the presence
c) of an auxiliary and, if appropriate,
d) of a granulation aid,
   and optionally removing the granulation aid,
   and optionally sorting to extract agglomerates of suitable size,
   and optionally treating agglomerates of unsuitable size and returning them to the agglomerating process.

Components a) to d) can be mixed and granulated in one operation or in various separate operations in any desired sequence.

Specific energy input of from 0.1 to 0.4 kW/kg is preferred during the granulation process.

The agglomeration process takes place in one or more stages preferably at a pressure of from 10 to 100 000 000 Pa, over a period of from 0.01 to 1000 h and at a temperature of from −20 to +500° C., particularly preferably from 50 to 350° C.

The granulation aid is preferably at least one member of the group of alcohols, ketones, hydrocarbons, water.

It is preferable to add from 5 to 50% by weight of granulation aid, based on dry solid, particularly preferably from 10 to 40% by weight.

The agglomerating process preferably takes place in mixers of the following type: double-cone mixers from TELSCHIG Verfahrenstechnik GmbH, twin-shaft paddle mixers from Eirich, Flexomix mixers from Schugi, fluidized-bed mixers from TELSCHIG Verfahrenstechnik GmbH, fluid mixers from Thyssen Henschel Industrietechnik GmbH, free-fall mixers from TELSCHIG Verfahrenstechnik GmbH (WPA6) or Hauf, intensive mixers—mixers from Eirich (e.g. R02, R 12, DE 18, Evactherm, conical-screw mixers from Nauta, in which the mix is circulated by a screw, using the Archimedes principle, cooling mixers from Papenmeier or Thyssen Henschel Industrietechnik GmbH, air-jet mixers from TELSCHIG Verfahrenstechnik GmbH, plowshare mixers from Lödige (M5 or M20), TELSCHIG Verfahrenstechnik GmbH, or Minox (PSM 10 to 10 000), planetary mixers from Hobart, annular- and annular-layer mixers from Lödige, (e.g. CB30, CB Konti-Mischer), Niro (HEC), Drais/Mannheim (e.g. K-TTE4), spray mixers from TELSCHIG Verfahrenstechnik GmbH, tumbling or container mixers, e.g. from Thyssen Henschel Industrietechnik GmbH, zig-zag mixers from Niro.

The inventive process can be carried out either in high-intensity mixers or in low-speed mixers.

High-intensity mixers can be operated at low speed in a first stage of the process, and if low-speed mixers are used, the energy input needed for a second stage of the process can be supplied via additional assemblies, such as knife rings.

Examples of high-speed mixers are the Lödige™ CB 30 Recycler, the Schugi™ granulator, the Schugi™ Flexomix, the Eirich™ R mixer, or the Drais™ K-TTP 80.

Examples of low-speed mixer-granulators are the Drais™ K-T 160 and the Lödige™ KM 300. The latter is often termed the Lödige plowshare mixer. Preferred peripheral velocities of the mixing units in suitable plowshare mixers are from 2 to 7 m/s, whereas the peripheral velocities of other suitable mixers are from 3 to 50 m/s, in particular from 5 to 20 m/s.

The granulation aid is preferably removed via drying.

Convective driers with dessicant flowing over the product to be dried are preferred, e.g. chamber driers, duct driers, belt driers, mixing driers (disk driers, drum driers, paddle driers).

Convective driers with dessicant flowing through the product to be dried are preferred, e.g. kilns (roaster driers), chamber tray driers, paddle driers (centrifugal driers), mill driers.

Convective driers with dessicant flowing around the product to be dried are preferred, e.g. flotation driers (pneumatic driers, fluidized-bed driers, cyclone driers, spray driers), spherical-bed driers (spherical-substrate driers).

Contact driers are preferred, e.g. drying cabinets, thin-film driers, (spiral-tube pneumatic driers, cylinder driers, screw evaporators), mixer-driers (multitube revolving driers, disk-drum driers, paddle driers).

Vacuum driers are preferred, e.g. vacuum drying cabinets, vacuum cylinder driers, vacuum paddle driers.

The temperature of gas inlet to the driers is from 50 to 320° C., preferably from 60 to 250° C., and the output temperature is preferably from 25 to 180° C.

Agglomerates of suitable size are extracted via the classification methods of the prior art (sieving, sifting, etc.).

The preferred method of treatment of agglomerates of unsuitable grain size is milling.

Flame-Retardant Polymer Molding Composition

The invention also provides a flame-retardant polymer composition which comprises the inventive phosphorus-containing thermally stabilized flame retardant agglomerates.

The flame-retardant polymer molding composition preferably comprises

from 1 to 50% by weight of phosphorus-containing thermally stabilized flame retardant agglomerates,

from 1 to 99% by weight of polymer or a mixture of these

from 0 to 60% by weight of additives

from 0 to 60% by weight of filler.

The flame-retardant polymer molding composition particularly preferably comprises

from 5 to 30% by weight of phosphorus-containing thermally stabilized flame retardant agglomerates,

from 5 to 90% by weight of polymer or a mixture of these

from 5 to 40% by weight of additives

from 5 to 40% by weight of filler.

The polymer is preferably a thermoplastic or thermoset polymer.

The thermoset polymer is preferably formaldehyde polymers, epoxy polymers, melamine-phenolic resin polymers, and/or polyurethanes.

The thermoplastic polymers are preferably HI (high-impact) polystyrene, polyphenylene ethers, polyamides, polyesters, polycarbonates, and blends or polymer blends of the type represented by ABS (acrylonitrile-butadiene-styrene) or PC/ABS (polycarbonate/acrylonitrile-butadiene-styrene).

The thermoplastic polymers are in particular polyamide, polyester, or ABS.

Flame-Retardant Polymer Moldings

The invention also provides polymer moldings, polymer films, polymer filaments, and polymer fibers which comprise the inventive phosphorus-containing thermally stabilized flame retardant agglomerates and/or which comprise the inventive flame-retardant polymer molding compositions.

The polymer moldings, polymer films, polymer filaments, and polymer fibers preferably comprise

from 1 to 50% by weight of phosphorus-containing thermally stabilized flame retardant agglomerates,

from 1 to 99% by weight of polymer or a mixture of these

from 0 to 60% by weight of additives

from 0 to 60% by weight of filler.

The polymer moldings, polymer films, polymer filaments, and polymer fibers particularly preferably comprise

from 5 to 30% by weight of phosphorus-containing thermally stabilized flame retardant agglomerates

from 5 to 90% by weight of polymer or a mixture of these

from 5 to 40% by weight of additives

from 5 to 40% by weight of filler.

Determination of Grain Size Distribution Via Sieve Analysis

The inserts with appropriate sieves are used in a Retsch sieving machine. The mesh width of the sieves here decreases from the top to the bottom. 50 g of the powder to be tested are applied to the widest sieve. The vibratory movement of the sieving machine causes the pulverulent material to move through the various sieves. The residues on the sieves are weighed, and a calculation is made to relate these to the weight of material used. From the values it is possible to calculate d₅₀ (average particle diameter) and d₉₀ values.

Determination of Color Values

The granulated material to be tested is heat-treated at 280° C. in a muffle furnace. A ®Luci 100 colorimeter from Dr. Lange is then used to determine whiteness. The color values stated are the Hunter system (CIE-LAB system) values. L values extend from 0 (black) to 100 (white), a values from −a (green) to +a (red), and b values from −b (blue) to +b (yellow). The more negative the b value, the more intensely blue is the material tested.

Abrasion Value

The specimen is sieved using a VE 1000 vibrator from Retsch for 2 min at 2 mm amplitude without interruption by way of a 0.2 mm sieve. The amount of specimen is to be selected in such a way that at least 50 g of material coarser than 200 μm are present after the sieving process. 50 g of the fraction coarser than 200 μm are weighed with 0.1 g accuracy into a 200 μm sieve. 18 steel spheres (diameter 10 mm, total weight 72.8 g) are added, and then the sieving machine is started for 5 min at 2 mm amplitude without interruption. After the milling process, the steel spheres are removed and the entire specimen is applied to a 200 μm sieve and again sieved at 2 mm amplitude without interruption for 2 min. The percentage proportion of material finer than 200 μm gives the abrasion value.

### EXAMPLE 1 (COMPARISON)

3.920 g of aluminum phosphinate are used as initial charge in a 20 l plowshare mixer from Lödige. 0.080 kg of PVA dissolved in 1.333 kg of water are applied by spraying within a period of 15 min, at room temperature. This takes place with continuous mixing at a specified rotation rate (about 230 rpm) and with knife heads in operation. Mixing is then continued for 5 min. The product is dried in a laboratory drier from Retsch for 60 min at an air input temperature of 120° C., then sieved through two sieves (200 μm and 1700 μm). Good product is the fraction of grain size greater than 200 μm and below 1700 μm.

### EXAMPLE 2

An agglomerate is prepared as in example 1 from 3.920 g of aluminum phosphinate and 0.178 kg of PCA dissolved in 1.236 kg of water, via mixing, drying, and sieving.

### EXAMPLE 3 (COMPARISON)

1470 kg of a mixture composed of 67% by weight of aluminum phosphinate and 33% by weight of synergist 1, and a solution of 30 kg of PVA in 448 kg of water are mixed with one another in a mixer from Schugi (Flexomix 160) with downstream batch fluidized bed for a period of one hour, and after-dried (air input temperature 150° C.) to the desired moisture content. The product is isolated by sieving, using an Allgaier sieve, via an 800 μm sieve and by way of a 200 μm sieve.

### EXAMPLE 4

An agglomerate is prepared as in example 4, from 1470 kg of a mixture composed of 67% by weight of aluminum phosphinate and 33% by weight of synergist 1, and from a solution of 67 kg of PCA in 411 kg of water, via mixing, drying, and sieving.

### EXAMPLE 5

0.376 kg of a mixture of 10% by weight of aluminum phosphinate and 90% by weight of synergist 1 are used as initial charge on a dish granulator of diameter 70 cm and are granulated by applying a sprayed solution of 0.050 kg of PAS in 0.264 kg of water. The rotation rate of the dish is 70 rpm, the angle of incidence is from 70 to 75°, and the temperature is room temperature. The product is dried in a Retsch laboratory drier for 60 min, using an air input temperature of 120° C., and then sieved via two sieves (600 μm and 3000 μm). Good product is the fraction whose grain size is greater than 600 μm and smaller than 3000 μm.

### EXAMPLE 6

An agglomerate is prepared as in example 1 from 3.978 kg of a mixture of 90% by weight of aluminum phosphinate and 10% by weight of synergist 1, and from a solution of 0.067 kg of PSS dissolved in 1.668 kg of water, via mixing, drying, and sieving.

### EXAMPLE 7

An agglomerate is prepared as in example 1 from 3.962 kg of a mixture of 64% by weight of aluminum phosphinate, 31% by weight of synergist 1, and 5% by weight of synergist 2, and from a solution of 0.160 kg of PMS dissolved in 1.594 kg of water, via mixing, drying, and sieving.

### EXAMPLE 8

An agglomerate is prepared as in example 5 from 0.380 g of a mixture of 92% by weight of aluminum phosphinate and 10% by weight of synergist 2, and from a solution of 0.054 kg of Na 4/1 dissolved in 0.263 kg of water, via mixing, drying, and sieving.

### EXAMPLE 9

2.626 kg of aluminum phosphinate and 1.294 kg of synergist are mixed in a Lödige plowshare mixer. An agglomerate is then prepared as in example 1 via spray-application of 0.402 kg of AM dissolved in 1.952 kg of water, and then drying and sieving.

### EXAMPLE 10

1.280 kg of aluminum phosphinate and 2.640 kg of synergist 1 are mixed in a 20 l plowshare mixer from Lödige. 2.135 kg of water are applied by spraying within a period of 15 min at room temperature. 0.039 kg of EVA are then metered in over a period of 5 min. This takes place with continuous mixing at specified rotation rate (about 230 rpm) and with knife heads in operation. Mixing is then continued for 5 min. The product is dried in a laboratory drier from Retsch for 60 min at an air input temperature of 120° C., then sieved via two sieves (200 μm and 1700 μm). Good product is the fraction whose grain size is greater than 200 μm and smaller than 1700 μm.

It has been found that selection of a suitable auxiliary can substantially prevent discoloration on heating of the phosphorus-containing flame retardant agglomerates, as shown by comparison of the color values of examples 1 and 3 (comparative examples) with the color values of the inventive examples 2 and 4 to 10. In the inventive examples, this is seen from the high L color values (inventive range: from 80 to 99.9, particularly preferably from 85 to 98) and from the low a and b color values (inventive ranges: a color values from −2 to +2, particularly preferably from −1 to +1.5 and b color values from −2 to +8, particularly preferably from −1 to +7.

TABLE 1

| | | | Example | | | | | | | | | |
|---|---|---|---|---|---|---|---|---|---|---|---|---|
| | | | 1 | | 3 | | | | | | | |
| | | | Comp. | 2 | Comp. | 4 | 5 | 6 | 7 | 8 | 9 | 10 |
| Component A | Aluminum | [% by wt.] | 98 | 98 | 66 | 66 | 9.5 | 89.6 | 63 | 85.5 | 66 | 32 |
| | phosphinate | | | | | | | | | | | |
| Component B | Synergist 1 | [% by wt.] | | | 32 | 32 | 84.5 | 9.9 | 31 | | 32 | 66 |
| Component C | Synergist 2 | [% by wt.] | | | | | | | 5 | 9.5 | | |
| Component D | PVA | [% by wt.] | 2 | | 2 | | | | | | | |
| | PCA | [% by wt.] | | 2 | | 2 | | | | | | |
| | PAS | [% by wt.] | | | | | 5 | | | | | |
| | PSS | [% by wt.] | | | | | | 0.5 | | | | |
| | PSM | [% by wt.] | | | | | | | 1 | | | |
| | Na 4/1 | [% by wt.] | | | | | | | | 5 | | |
| | AM | [% by wt.] | | | | | | | | | 0.5 | |
| | EVA | [% by wt.] | | | | | | | | | | 0.5 |
| | Whiteness | L value | 70.93 | 94.9 | 74.4 | 88.35 | 93.93 | 93.09 | 92.95 | 95.87 | 92.7 | 93.0 |
| | Whiteness | a value | 4.74 | 0.06 | 3.26 | 1.05 | 0.27 | 0.25 | −0.49 | 0.03 | 0.4 | 0.1 |
| | Whiteness | b value | 12.97 | 0.31 | 10.57 | 6 | 1.59 | 2.99 | 2.87 | 0.22 | 3.6 | 1.3 |
| | Residual moisture | [% by wt.] | 0.2 | 0.3 | 0.3 | 0.6 | 0.5 | 0.4 | 0.3 | 0.3 | 0.4 | 0.4 |
| | level | | | | | | | | | | | |
| | Abrasion value | [%] | 71 | 34 | 57 | 75 | 83 | 81 | 87 | 95 | 77 | 63 |

TABLE 2

| | | | Example | | | | | | | | | |
|---|---|---|---|---|---|---|---|---|---|---|---|---|
| | | | 1 | | 3 | | | | | | | |
| | | | Comp. | 2 | Comp. | 4 | 5 | 6 | 7 | 8 | 9 | 10 |
| Component A | Aluminum | [kg] | 3.920 | 3.920 | | | | | | | 2.626 | 1.280 |
| | phosphinate | | | | | | | | | | | |
| | Mixture of | [kg] | | | 1470 | 1470 | 0.376 | 3.978 | 3.962 | 0.380 | | |
| | aluminum | | | | | | | | | | | |
| | phosphinate | | | | | | | | | | | |
| | and | | | | | | | | | | | |
| | synergists | | | | | | | | | | | |
| Component B | Synergist 1 | | | | | | | | | | 1.294 | 2.640 |
| | Water | [kg] | 1.333 | 1.236 | 448 | 411 | 0.264 | 1.668 | 1.594 | 0.263 | 1.952 | 2.135 |
| Component D | PVA | [kg] | 0.080 | | 30 | | | | | | | |
| | PCA | [kg] | | 0.178 | | 67 | | | | | | |
| | PAS | [kg] | | | | | 0.050 | | | | | |
| | PSS | [kg] | | | | | | 0.067 | | | | |
| | PSM | [kg] | | | | | | | 0.160 | | | |
| | Na 4/1 | [kg] | | | | | | | | 0.054 | | |
| | AM | [kg] | | | | | | | | | 0.402 | |
| | EVA | [kg] | | | | | | | | | | 0.039 |

Chemicals used

| | |
|---|---|
| Aluminum | ® Exolit OP1230 from Clariant GmbH |
| phosphinate | |
| AM | aqueous acrylate-methacrylate polymer dispersion, |
| | 49.8%, ® Acronal 18D, BASF |
| EVA | aqueous ethylene-acrylate-vinyl acetate terpolymer |
| | dispersion, about 51% by weight, ® Airflex EAF375, |
| | Air Products |
| Na 4/1 | aqueous sodium silicate solution, 8.3% by weight |
| | of Na₂O, 28.18% by weight of SiO₂, Clariant France |
| PAS | polyacrylic acid, sodium salt MW = 30 000 40% by |
| | Weight aqueous solution, Sigma-Aldrich |
| PCA | acrylic/maleic acid copolymer, sodium salt MW = 50 000 |
| | ® Sokalan CP 5, 45% by weight solution, |
| | BASF |
| PSM | 4-styrenesulfonic acid-maleic acid copolymer, |
| | sodium salt MW = 20 000 25% aqueous solution, |
| | Sigma-Aldrich |
| PSS | poly(4-styrenesulfonate), sodium salt 30% by |
| | weight aqueous solution, Sigma-Aldrich |
| PVA | polyvinyl alcohol, ® Mowiol 3-85, Kuraray |
| Synergist 1 | ® Melapur 200-70, Ciba SC |
| Synergist 2 | ® Firebrake 500, Borax |

1. A phosphorus-containing thermally stabilized flame retardant agglomerate, comprising
as component A from 6 to 99.99% by weight of aggregates and/or primary particles comprising a phosphinic salt of the formula (I), a diphosphinic salt of the formula (II), a polymer of the phosphinic salt of the formula (I), a polymer of the diphosphinic salt of the formula (II) or a mixture thereof, 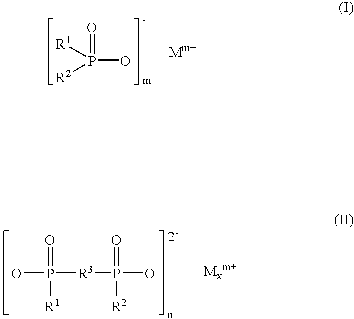
where
R¹ and R² are identical or different and are C1-C6-alkyl, linear or branched, or aryl;
R³ is C₁-C₁₀-alkylene, linear or branched, C₆-C₁₀-arylene, -alkylarylene, or -arylalkylene;
M is Mg, Ca, Al, Sb, Sn, Ge, Zn, Ti, Fe, Zr, Ce, Bi, Sr, Mn, Li, Na, K, or a protonated nitrogen base;
m is from 1 to 4; n is from 1 to 4; and x is from 1 to 4;
as component B from 0 to 90% by weight of at least one synergist comprising a nitrogen compound, a phosphorus compound or a phosphorus-nitrogen compound;
as component C from 0 to 20% by weight of at least one compound of the elements of the second main and transition group; and
as component D from 0.01 to 20% by weight of at least one auxiliary.

2. The phosphorus-containing thermally stabilized flame retardant agglomerate as claimed in claim 1, comprising
from 20 to 99.9% by weight of component A;
from 0 to 74% by weight of component B;
from 0 to 10% by weight of component C; and
from 0.1 to 5% by weight of component D.

3. The phosphorus-containing thermally stabilized flame retardant agglomerate as claimed in claim 1, comprising
from 6 to 99.99% by weight of component A;
from 6 to 90% by weight of component B;
from 0 to 20% by weight of component C; and
from 0.01 to 20% by weight of component D.

4. The phosphorus-containing thermally stabilized flame retardant agglomerate as claimed in claim 1, comprising
from 20 to 99.9% by weight of component A;
from 20 to 74% by weight of component B;
from 0 to 10% by weight of component C; and
from 0.1 to 5% by weight of component D.

5. The phosphorus-containing thermally stabilized flame retardant agglomerate as claimed in claim 1, comprising
from 6 to 99.89% by weight of component A;
from 6 to 90% by weight of component B;
from 0.1 to 20% by weight of component C; and
from 0.01 to 20% by weight of component D.

6. The phosphorus-containing thermally stabilized flame retardant agglomerate as claimed in claim 1, comprising
from 20 to 98.9% by weight of component A;
from 20 to 74% by weight of component B;
from 1 to 10% by weight of component C; and
from 0.1 to 5% by weight of component D.

7. The phosphorus-containing thermally stabilized flame retardant agglomerate as claimed in claim 1, wherein component B is melamine phosphate, melamine pyrophosphate, melamine polyphosphates, melam polyphosphates, melem polyphosphates, melon polyphosphates, melamine cyanurate, or melamine condensates.

8. The phosphorus-containing thermally stabilized flame retardant agglomerate as claimed in claim 1, wherein component C is at least one compound of the elements calcium, magnesium zinc or a mixture thereof.

9. The phosphorus-containing thermally stabilized flame retardant agglomerate as claimed in claim 1, wherein component C is magnesium hydroxide, magnesium carbonate, magnesium borate, calcium carbonate, calcium borate, calcium pyroborate, zinc oxide, zinc hydroxide, zinc borate, zinc phosphate, zinc pyrophosphate or a mixture thereof.

10. The phosphorus-containing thermally stabilized flame retardant agglomerate as claimed in claim 1, wherein the at least one auxiliary is a homopolymer or mixed polymer based on at least one monomer selected from the group consisting of 1,2-butadiene, 1,3-butadiene, 2-ethylhexyl acrylate, acrylamide, acrylic ester, acrylonitrile, acrylic acid, amides, caprolactam, crotonic acid, dibutyl maleate, epoxides, esters, ethyl acrylate, ethylene, ethylene glycol, ethylhexyl acrylate, ethyl methacrylate, hydroxyacrylic acid, isobutyl acrylate, isobutyl methacrylate, lauryl acrylate, maleic acid, maleic anhydride, methacrylamide, methacrylate, methacrylonitrile, methacrylic acid, methallylsulfonic acid, methyl methacrylate, methylstyrene, lactic acid, mono-, di-, or oligosaccharides, n-butyl acrylate, n-butyl methacrylate, n-hexyl acrylate, n-hexyl methacrylate, N-hydroxymethylacrylamide, n-propyl acrylate, N-vinylpyrrolidone, olefins, polyvinyl butyral, polyvinylcaprolactam, propylene, sec-butyl acrylate, stearates, styrene, styrenesulfonic acid, tert-butyl acrylate, tert-butyl chloride, tert-butyl methacrylate, urethanes, vinyl acetate, vinyl alcohol derivatives, vinylcaprolactam, vinyl chloride, vinyl ester, vinyl ethers, vinylidene chloride, vinyl laurate, vinyl methyl ethers, vinyl propionate, vinylpyrrolidone, degraded starch, aldehyde starches, alkylcellulose, alkylhydroxyethylcellulose, alkyl, carboxyalkylcellulose (Na salt), hydroxyethylcellulose, hydroxypropylcellulose, sodium carboxymethylcellulose, and a mixture thereof.

11. The phosphorus-containing thermally stabilized flame retardant agglomerate as claimed in claim 1, wherein the at least one auxiliary is polyvinylpyrrolidone, polycarboxylates, polystyrenesulfonic acid, polystyrenesulfonic acid-maleic anhydride copolymers, waterglass, vinyl acetate polymers, acrylate polymers, polylactic acid, starch cellulose derivatives or a mixture thereof.

12. The phosphorus-containing thermally stabilized flame retardant agglomerate as claimed claim 1, wherein the L color values of the phosphorus-containing thermally stabilized flame retardant agglomerate after heat treatment are from 80 to 99.9.

13. The phosphorus-containing thermally stabilized flame retardant agglomerate as claimed in claim 1, wherein the a color values are from −2 to +2.

14. The phosphorus-containing thermally stabilized flame retardant agglomerate as claimed in claim 1, wherein the b color values are from −2 to +8.

15. A process for preparation of phosphorus-containing thermally stabilized flame retardant agglomerates as claimed in claim 1, comprising the steps of agglomerating aggregates and/or primary particles composed of a phosphinic salt of the formula (I) and/or of a diphosphinic salt of the formula (II), a polymer of a phosphinic salt of the formula (I), a polymer of the diphosphinic salt of the formula (II) or a mixture thereof in the presence of the at least one auxiliary and, optionally, of a granulation aid, optionally removing the granulation aid, optionally sorting to extract agglomerates of suitable size, and optionally treating agglomerates of unsuitable size and returning them to the agglomerating process.

16. The process as claimed in claim 15, wherein at least one synergist and/or the at least one compound of the elements of the second main and transition group are added during the agglomerating step.

17. A flame-retardant polymer article comprising phosphorus-containing thermally stabilized flame retardant agglomerates as claimed in claim 1, wherein the flame-retardant polymer article is selected from the group consisting of a molding compositions, a flame-retardant polymer molding, flame-retardant polymer film, flame-retardant polymer filament and a flame-retardant polymer fiber.

18. A flame-retardant polymer molding composition, comprising
from 1 to 50% by weight of phosphorus-containing thermally stabilized flame retardant agglomerates as claimed in claim 1,
from 1 to 99% by weight of polymer or a mixture of polymers,
from 0 to 60% by weight of at least one additive, and
from 0 to 60% by weight of at least one filler.

19. A process for preparation of flame-retardant polymer molding composition as claimed in claim 18, wherein the polymer or mixture of polymers are granulated, and comprising the steps of homogenizing the phosphorus-containing thermally stabilized flame retardant agglomerates with the granulated polymer or mixture of polymers and, optionally, with the at least one additive in a compounding assembly at relatively high temperatures form a homogenized polymer strand, drawing off and cooling the homogenized polymer strand and dividing the homogenized polymer strands into portions.

20. A polymer molding, polymer film, polymer filament, or polymer fiber comprising from 1 to 50% by weight of phosphorus-containing thermally stabilized flame retardant agglomerates as claimed in claim 1
from 1 to 99% by weight of polymer or a mixture of polymers,
from 0 to 60% by weight of at least one additive, and
from 0 to 60% by weight of at least one filler.

21. A flame-retardant polymer molding, flame-retardant polymer film, flame-retardant polymer filament, or flame-retardant polymer fiber, comprising the flame-retardant polymer molding composition as claimed in claim 18.

22. The flame-retardant polymer molding, flame-retardant polymer film, flame-retardant polymer filament, or flame-retardant polymer fiber as claimed in claim 21, comprising
from 60 to 98% by weight of the flame-retardant polymer molding composition,
from 2 to 40% by weight of polymer or a mixture polymers.

23. A process for production of flame-retardant polymer moldings, of flame-retardant polymer films, of flame-retardant polymer filaments, or of flame-retardant polymer fibers as claimed in claim 22, comprising the step of processing the flame-retardant polymer molding composition via injection molding and at least one of compression molding, foam injection molding, internal-gas-pressure injection molding, blowmolding, cast-film methods, calendering, lamination, or coating at relatively high temperatures to give the flame-retardant polymer moldings, films, filaments or fibers.

24. The phosphorus-containing thermally stabilized flame retardant agglomerate as claimed in claim 1, wherein component B is melam, melem, or melon.

25. The phosphorus-containing thermally stabilized flame retardant agglomerate as claimed in claim 10, wherein the at least one monomer is methyl.

26. The phosphorus-containing thermally stabilized flame retardant agglomerate as claimed claim 1, wherein the L color values of the phosphorus-containing thermally stabilized flame retardant agglomerate after heat treatment are from 85 to 98.

27. The phosphorus-containing thermally stabilized flame retardant agglomerate as claimed in claim 1, wherein the a color values are from −1 to +1.5.

28. The phosphorus-containing thermally stabilized flame retardant agglomerate as claimed in claim 1, wherein the b color values are from −1 to +7.
